(19) United States
(12) Patent Application Publication
(10) Pub. No.: US 2004/0097228 A1
(43) Pub. Date: May 20, 2004

(54) Method and a controller for facilitating mobile telephone roaming

(75) Inventor: Stephane Saada, Fontenay Sous Bois (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/703,452

(22) Filed: Nov. 10, 2003

(30) Foreign Application Priority Data
Nov. 12, 2002 (FR) 02 14 099

(51) Int. Cl. H04Q 7/20

(52) U.S. Cl. 455/432.1; 455/422.1; 455/450

(57) ABSTRACT

The invention relates to a method of managing calls in a mobile telephone network comprising a network core, and a network controller controlling base stations, the base station controller being used to control the transfer of an ongoing call on the network to a target network when the mobile terminal is about to leave the coverage zone of the first network (R1). In order to enable the transfer to take place to the target network (R2, R3, R4), the network core transmits information to the controller representing the rights available to the mobile terminal, this information being distinct from the international identity code of the mobile subscriber. The information relating to rights is preferably inserted in the temporary mobile subscriber identity (TMSI) code.

The invention relates to a method of facilitating mobile telephone roaming. The invention also relates to a network making use of such a method and to equipment of the network.

In a mobile telephone system, each terminal communicates with the base station of the cell in which it is to be found, and it is the base station which puts the mobile telephone into communication with the network as a whole.

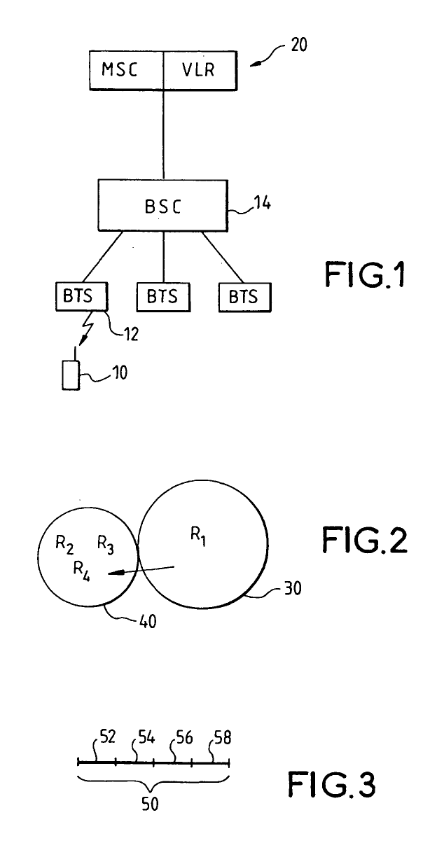

FIG. 1 represents a mobile telephone network. A telephone 10 communicates by radio with a base station 12 BTS. The base station 12 is connected to the core of the network 20 via a base station controller 14. It is thus via the core of the network that the mobile telephone communicates with other mobile telephones or with fixed telephones or with other telecommunications terminals.

In the core of the network, there is a mobile switching center (MSC) and a visitor location register (VLR) which is a database that provides information concerning all of the mobile telephones connected to the switching center.

In general, such a telecommunications network is managed by an operator or by a small number of operators.

Operators have made agreements in order to enable roaming, i.e. in order to enable a mobile telephone to communicate when it is in a cell belonging to an operator with which that telephone has not taken out a subscription. In order to implement such agreements, each mobile terminal is given an international mobile subscriber identity (IMSI). This code identifies the mobile terminal without ambiguity and includes an identifier of the operator with which the terminal has a subscription and the corresponding rights of the subscriber.

The IMSI code is not continuously transmitted to the base station 12 for reasons of security since radiocommunication between the mobile telephone 10 and the base station 12 is easily picked up and that would allow a dishonest person to obtain the IMSI code and take advantage of the corresponding rights. The code is conserved only in the VLR database in the network core 20. However, in order to enable the mobile telephone 10 to be continuously identified when it is within the coverage of the network 14, 20, it is given a temporarily mobile subscriber identity (TMSI).

When the mobile telephone begins to leave the zone covered by the network 14, 20, e.g. on crossing a frontier, it is the controller 14 which needs to take the decision to transfer an ongoing call to another network to which it directs the mobile telephone. However, since the temporary TMSI code does not contain information about the original operator of the mobile telephone, this controller cannot determine whether the mobile telephone does or does not have rights to communicate with one or more adjacent networks. Under such conditions, the ongoing call is interrupted and can be continued once the mobile telephone has transferred its IMSI code to the core of the neighboring network.

In order to remedy this drawback, proposals have been made to store the IMSI code in the controllers 14. However such a transfer, for which standards are presently under discussion, implies modifying the interface between the network core 20 and the controller 14, and also implies greater memory capacity in the controller 14 than is presently available since IMSI codes present a number of bits that is considerably greater than the number of bits in temporary TMSI codes.

The invention provides a method enabling a transfer to take place between one network and another without interrupting an ongoing call, which method is particularly simple to implement.

In the method of the invention, the core of the network transmits information which is different from the IMSI code to the base station controller, said information representing the rights available to the mobile telephone. This information is preferably encoded on a number of bits that is smaller than the standardized code representing the operator and the rights of the mobile telephone (HPLMN code).

In an implementation, in order to limit the number of information bits representing the rights of the mobile telephone, the list of neighboring networks with which the mobile telephone has the right to communicate is transmitted to the base station controller. For example, if three networks that are authorized for the mobile telephone are to be found in the vicinity of the network in which the mobile is momentarily present but is about to leave, then the base station controller transfers the call to one of those networks if only one of them is available, or if a plurality of neighboring networks are available, the controller transfers the call in application of a predetermined criterion such as a random selection, or selects the network that provides best reception. If one of the neighboring networks corresponds to the network with which the mobile telephone has a subscription, then naturally that network will constitute the target network.

It should be observed that the neighboring networks may be operated by the same operator but that the operator has two different types of network, for example a GSM network and a UMTS network. Under such circumstances, the code transmitted to the base station controller of the original network represents the right to access the UMTS network or the GSM network and thus allows ongoing calls to be transferred to the network which the subscriber is entitled to access.

In the preferred implementation of the invention, the information relating to the subscriber's rights is included in the temporary TMSI code.

When the TMSI code is used for transmitting the rights available to the subscriber, none of the network equipment needs significant modification, nor is greater memory capacity required. Under such circumstances, it suffices for the equipment of the network core to include means for transmitting to the base station controller information concerning the rights available to the mobile telephone, which information is preferably included in the temporary TMSI code.

Thus, in general, the invention provides a method of managing calls in a mobile telephone network comprising a network core, and a network controller controlling base stations, the base station controller being used to control the transfer of an ongoing call on the network to a target network when the mobile terminal is about to leave the coverage zone of the first network. This method is characterized in that in order to enable the transfer to take place to the target network, the network core transmits information to the controller representing the rights available to the mobile terminal, this information being distinct from the international identity code of the mobile subscriber.

In an implementation, the information communicated to the base station controller concerning the rights of the mobile terminal is restricted to rights relating to the neighboring networks.

In an implementation, the target network is selected in application of a predetermined criterion whenever a plurality of target networks are available, the predetermined criterion being best reception, for example.

Preferably, the information relating to rights is inserted in the temporary mobile subscriber identity (TMSI) code. In which case, the portion of the TMSI code designating the subscriber includes fields relating to the subscriber's rights in each of the neighboring networks.

The invention also provides a base station controller of a telecommunications network for mobile telephones, the controller being characterized in that it includes means for receiving information from the network core in respect of each mobile terminal, which information is distinct from the international mobile subscriber identity of the mobile subscriber and relates to the rights available to the subscriber.

In an embodiment, the information communicated to the base station controller relating to the rights of the mobile terminal is restricted to its rights over the neighboring networks.

The controller may include means for causing an ongoing call to be transferred to a neighboring network selected as a function of the information relating to the subscriber's rights.

Preferably, the information relating to the subscriber's rights is inserted in the temporary mobile subscriber identity (TMSI) code. In which case, the portion of the TMSI code designating the subscriber includes fields relating to the subscriber's rights over each of the neighboring networks.

The invention also provides network core equipment for a telecommunications network for mobile terminals, which equipment is characterized in that it includes means for sending information in respect of each mobile terminal to at least one base station controller, which information relates to the rights available to the subscriber and is distinct from the international mobile subscriber identity code.

Other characteristics and advantages of the invention appear from the following description of implementations given with reference to the accompanying drawing, in which:

FIG. 1, described above, is a diagram of a mobile telephone network;

FIG. 2 shows a mobile telephone in a zone covered by one network and about to enter into a zone where there are a plurality of other networks; and

FIG. 3 represents a portion of a temporary code used in accordance with the invention.

As explained above, the problem which the present invention seeks to solve consists in enabling a mobile terminal leaving a zone 30 covered by a network R1 in order to penetrate into a zone 40 covered by networks R2, R3, and R4 to be transferred to one of those networks without an ongoing call being interrupted and with minimum modification to the preexisting networks R1, R2, R3, and R4 (FIG. 2).

To this end, in the example described, the temporary mobile subscriber identity code is used to provide information concerning the rights available to the subscriber.

In this example, the number of bits selected in the TMSI code is smaller than the number of bits in the HPLMN code. Thus, in the example shown in FIG. 3, the TMSI code has a field 50 subdivided into four portions. The first portion 52 represents the network R2, the portion 54 represents the network R3, the portion 56 represents the network R4, and the portion 58 corresponds to some other mention. If the mobile terminal 10 is entitled only to the network R2, then one or more bits in the field 52 are used for specifying this entitlement. Similarly, if the mobile terminal 10 has access rights to network R3 or network R4, then one or more bits in the fields 54 or 56 are used to indicate these rights. Finally, if the mobile terminal can access two or three of the networks R2, R3, and R4, then the field 58 is used to specify a criterion for selecting the target network, for example a random selection or a selection corresponding to best reception. It should be observed that the field 50 corresponds to a preexisting portion of the TMSI code that does not have any syntax.

Thus, the controller 14 of the network R1 transmits to the controller corresponding to the selected target network R2, R3, or R4 the information that the call is to be transferred to that target network.

1. A method of managing calls in a mobile telephone network comprising a network core (20), and a network controller (14) controlling base stations (12), the base station controller being used to control the transfer of an ongoing call on the network to a target network when the mobile terminal is about to leave the coverage zone of the first network, the method being characterized in that in order to enable the transfer to take place to the target network (R2, R3, R4), the network core transmits information to the controller (14) representing the rights available to the mobile terminal, this information being distinct from the international identity code of the mobile subscriber.

2. A method according to claim 1, characterized in that the information communicated to the base station controller concerning the rights of the mobile terminal is restricted to rights relating to the neighboring networks (R2, R3, R4).

3. A method according to claim 1, characterized in that the target network is selected in application of a predetermined criterion whenever a plurality of target networks are available, the predetermined criterion being best reception, for example.

4. A method according to claim 1, characterized in that the information relating to rights is inserted in the temporary mobile subscriber identity (TMSI) code.

5. A method according to claim 4, characterized in that the portion of the TMSI code designating the subscriber includes fields relating to the subscriber's rights in each of the neighboring networks.

6. A base station controller of a telecommunications network for mobile telephones, the controller being characterized in that it includes means for receiving information from the network core in respect of each mobile terminal, which information is distinct from the international mobile subscriber identity of the mobile subscriber and relates to the rights available to the subscriber.

7. A controller according to claim 6, characterized in that the information communicated to the base station controller relating to the rights of the mobile terminal is restricted to its rights over the neighboring networks (R2, R3, R4).

8. A controller according to claim 6, characterized in that it includes means for causing an ongoing call to be transferred to a neighboring network selected as a function of the information relating to the subscriber's rights.

9. A controller according to claim 6, characterized in that the information relating to the subscriber's rights is inserted in the temporary mobile subscriber identity (TMSI) code.

10. A controller according to claim 9, characterized in that the portion of the TMSI code designating the subscriber includes fields relating to the subscriber's rights over each of the neighboring networks.

11. Network core equipment for a telecommunications network for mobile terminals, which equipment is characterized in that it includes means for sending information in respect of each mobile terminal to at least one base station controller, which information relates to the rights available to the subscriber and is distinct from the international mobile subscriber identity code.
